(19) United States
(12) Patent Application Publication
(10) Pub. No.: US 2009/0132405 A1
(43) Pub. Date: May 21, 2009

(54) SYSTEM AND METHOD FOR AUTO-FILLING INFORMATION

(76) Inventors: German Scipioni, San Jose, CA (US); Jennifer Huang, San Jose, CA (US)

Correspondence Address: Haynes and Boone, LLP;IP Section, 2323 Victory Avenue, SUITE 700, Dallas, TX, 75219, US

(21) Appl. No.: 11/966,709

(22) Filed: Dec. 28, 2007

Related U.S. Application Data
(60) Provisional application No. 60/988,271, filed on Nov. 15, 2007.

(51) Int. Cl. G06Q 40/00

(52) U.S. Cl. 705/35

(57) ABSTRACT

Embodiments of the present disclosure provide a plug-in feature for a browser that allows for secure financial transactions on a communication network. The plug-in feature auto-fills transaction information including user-generated information, such as billing and/or shipping information of a user. The plug-in feature allows a user to store receipts in an efficient and convenient manner to track online shopping activities. The plug-in feature generates secure card numbers (e.g., single-use and/or multi-use secure card numbers) to pay for purchases. The plug-in feature may be implemented in a toolbar of a browser.

### CLAIM OF PRIORITY

The present application claims the benefit of priority to U.S. Provisional Patent Application Ser. No. 60/988,271 (Attorney Docket No. M-17153-V1 US) entitled, “SYSTEM AND METHOD FOR FACILITATING FINANCIAL TRANSACTIONS OVER A COMMUNICATION NETWORK,” filed Nov. 15, 2007, which is hereby incorporated by reference in its entirety.

### BACKGROUND

1. Field of the Invention

The present invention generally relates to facilitating financial transactions over a network and more particularly to auto-filling information.

2. Related Art

In online financial transactions, customers search for and purchase products and services through electronic communications with online merchants over electronic networks, such as the Internet. During the course of these transactions, customers may provide payment in various ways including, for example, credit cards, electronic fund transfers, and other payment techniques offered by payment providers.

Typically, when online shopping at a particular website, customers select items to purchase by clicking on a link for a specific item, and the selected items are placed on reserve in some type of virtual shopping cart. When done shopping, the customer proceeds to a checkout page to provide some form of payment for the selected items. At this point, the customer provides information for identification and payment. When the customer continues shopping and is ready to purchase items from another website, the customer is prompted to re-enter the same information for identification and payment.

This process can be tedious and inconvenient. Entering information for each online transaction is inefficient and time consuming. Thus, there currently exists a need to improve the process of purchasing items in online transactions.

### SUMMARY

Embodiments of the present disclosure provide a plug-in feature for a browser that allows for secure financial transactions on a communication network. In one aspect, when shopping on the communication network, the plug-in feature allows a user to auto-fill information, including various types of user-generated information, such as billing and/or shipping information, with a single menu selection from the plug-in feature. In another aspect, the plug-in feature allows a user to store receipts in an efficient and convenient manner to track online shopping activities. In still another aspect, the plug-in feature allows a user to generate and select secure card numbers (e.g., single-use and/or multi-use secure card numbers) to pay for purchases. As described in greater detail herein, the plug-in feature may be implemented in a toolbar of a browser for ease of access.

In accordance with an embodiment of the present disclosure, a system for facilitating financial transactions over a network includes a first component adapted to communicate with a user via a client device over the network and a second component adapted to receive a login request from the user via the client device over the network and process the login request by accessing an account related to the user based on user information passed with the login request. The second component provides transaction information from the user account to the client device for auto-fill of the transaction information during a financial transaction with a merchant. In one implementation, the transaction information comprises user-generated information including billing and/or shipping information.

In various implementations, the first component may be adapted to communicate with the client device via a browser application having a plug-in module. The plug-in module may be adapted to detect the financial transaction on a merchant site of the merchant. The plug-in module may be adapted to notify the user to auto-fill the transaction information. The plug-in module may be adapted to auto-fill the transaction information in a form field on a merchant site of the merchant when instructed by the user. The plug-in module may be adapted to provide a drop-down dashboard to the user from a toolbar of the browser application. The drop-down dashboard may provide a selection of auto-filling the transaction information of the user.

In various implementations, the second component may be adapted to verify the identity of the user based on the user information passed with the login request. The second component may comprise a payment processing application adapted to interface with one or more merchant devices on behalf of the client device during a financial transaction. The payment processing application may be adapted to interface with the user via the client device over the network to facilitate financial transactions between the client device and the one or more merchant devices.

In various implementations, the system may include third component adapted to maintain a plurality of accounts for one or more users and merchants, wherein the accounts may include account information related to the one or more users and merchants. The account information may include private financial information of the users and merchants including at least one or more account numbers, passwords, address information, credit card information, and banking information.

In accordance with an embodiment of the present disclosure, a method for facilitating financial transactions over a network includes receiving a login request from a user via the network, the request includes information related to the user, processing the request by accessing an account related to the user based on the user information passed with the login request, and completing the request by providing transaction information from the user account to the client device via the network for auto-fill of the transaction information during a financial transaction with a merchant.

These and other features and advantages of the present invention will be more readily apparent from the detailed description of the embodiments set forth below taken in conjunction with the accompanying drawings.

### BRIEF DESCRIPTION OF THE FIGURES

FIG. 1 shows a block diagram of a networked system configured to facilitate online financial transactions in accordance with an embodiment of the invention.

FIG. 2A shows one embodiment of a plug-in module implemented in a browser in accordance with an embodiment of the invention.

FIG. 2B shows a screen shot of a browser displaying various functions that may be provided by the plug-in module in accordance with embodiments of the invention.

FIG. 3 shows one embodiment of a method for generating secure card numbers with the plug-in module in accordance with an embodiment of the invention.

FIGS. 4A-4G show various screen shots of a browser displaying secure card management in accordance with embodiments of the invention.

FIG. 5 shows one embodiment of a method for auto-filling information with the plug-in module in accordance with an embodiment of the invention.

FIG. 6 shows a screen shot of a browser displaying auto-fill management in accordance with an embodiment of the invention.

FIG. 7 shows one embodiment of a method for generating and storing receipts with the plug-in module in accordance with an embodiment of the invention.

FIGS. 8A-8B show various screen shots of a browser displaying receipt management in accordance with embodiments of the invention.

FIG. 9 is a block diagram of a computer system suitable for implementing embodiments of the invention.

Embodiments of the invention and their advantages are best understood by referring to the detailed description that follows. It should be appreciated that like reference numerals are used to identify like elements illustrated in one or more of the figures, wherein showings therein are for purposes of illustrating embodiments of the invention and not for purposes of limiting the same.

### DETAILED DESCRIPTION

Embodiments of the present disclosure provide systems and methods for facilitating financial transactions by auto-filling information. In one implementation, a drop-down dashboard (e.g., menu) is provided to a user from a browser toolbar. When the user logs into an account related to the user, information related to the user (e.g., user-generated information including billing and/or shipping information) may be automatically retrieved from the user's account for auto-fill of the information into the web page. For example, when the user visits a web merchant, the dashboard may detect when form fields are present and notify the user from the dashboard to auto-fill the form field information. The user's billing and/or shipping address information may be retrieved from the user's account, which may be accomplished at login. The auto-fill feature may be adapted to automatically auto-fill billing and/or shipping address information based on user parameter settings and control. As such, the user may control the type of notifications received for individual web sites. For example, if a user visits a particular web site and provides indication for no auto-fill particular web site, then the auto-fill will not occur during subsequent visits to the particular web site unless changed by the user. In one implementation, the dashboard is provided as a drop-down window shade that slides up or down from a toolbar on the browser, which is more aesthetically pleasing to a user than a standard pop-up window. These and other embodiments of the present disclosure will be described in greater detail herein.

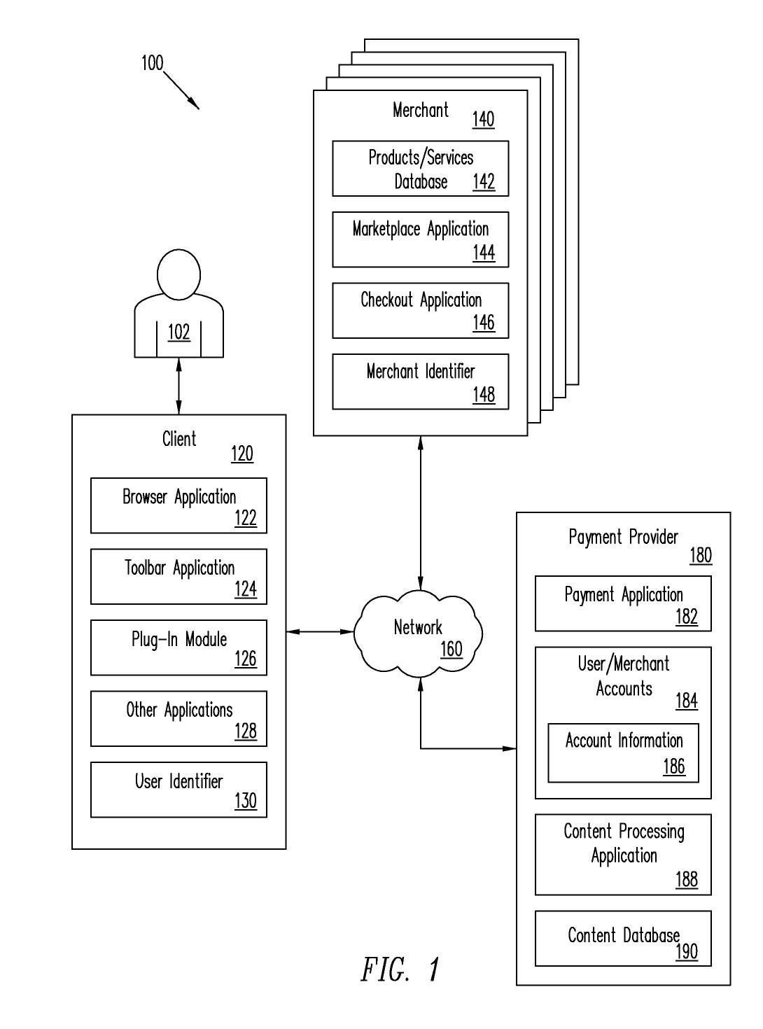

FIG. 1 shows one embodiment of a block diagram of a system 100 configured to facilitate financial transactions over a network 160. As shown in FIG. 1, system 100 includes at least one client device 120, one or more merchant servers 140, and at least one payment provider server 180 in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

The client device 120, in one embodiment, may be implemented using any appropriate combination of hardware and/or software configured for wired and/or wireless communication over the network 160. For example, the client device 120 may be implemented as a personal computer of a user 102 (e.g., a client or customer) in communication with the network 160, such as the Internet. In other examples, the client device 120 may be implemented as a wireless telephone (e.g., cell phone), personal digital assistant (PDA), notebook computer, and/or various other generally known types of computing devices.

The client device 120, in one embodiment, may include one or more browser applications 122 which may be used, for example, to provide a user interface to permit the user 102 to browse information available over the network 160. For example, the browser application 122 may be implemented as a web browser to view information available over the Internet.

The client device 120, in one embodiment, may include one or more toolbar applications 124, which may be used, for example, to provide client-side processing for performing tasks in response to operations selected by the user 102. For example, the toolbar application 124 may display a graphical user interface (GUI) in connection with the browser application 122.

The client device 120, in one embodiment, may include a plug-in module 126 for facilitating financial transactions on the network 160, including a secure cards feature, an auto-fill feature, and a receipt generation and storage feature, which are described in greater detail herein. In one implementation, the plug-in module 126 comprises a software program, such as a graphical user interface (GUI), executable by a processor that is configured to interface and communicate with the one or more merchant servers 140 and the payment provider server 180 via the network 160. The user 102 is able to access merchant sites, including merchant websites, via the merchant servers 140 to view and select items for purchase, and the user 102 is able to purchase selected items from the one or more merchants 140 by communicating with the payment provider server 180 via a network browser, such as a web browser.

When installed and executed by the client device 120, the plug-in module 126 is configured to provide and display a pull-down window having one or more menu options, on a display component (e.g., monitor) of the client device 120. In general, a pull-down window is a pictorial image used in a graphical user interface (GUI) to represent a software program, application, command, link to a web page, etc., wherein the user 102 may select an object or action by clicking on a related menu option (e.g., link) with a cursor control component (e.g., mouse). In one embodiment, upon installation of the plug-in module 126, the user 102 may be prompted to establish a user account with the payment provider server 180, wherein the user 102 may use the client device 120 to access the payment provider server 180 via the network 160. When establishing a user account, the user 102 may be asked to provide personal information, such as name, address, phone number, etc., and financial information, such as banking information, credit card information, etc.

As described herein, the plug-in module 126 may provide the menu selection items in a toolbar of a browser. However, in another implementation, the plug-in module 126 may comprise a stand-alone application that may be viewed separately from the browser as a different application, such as an add-on application or extension application. Therefore, embodiments of the present disclosure may include various other application types whether implemented as part of a browser or implemented as a stand-alone application, wherein a user 102 may access the functional components of the plug-in module 126 from, for example, the desktop of a computer. In another example, the browser may be adapted to access the plug-in module 126 from the desktop of a computer or from a file stored in a memory component of the computer, such as a database or hard-disk drive.

The client device 120, in one embodiment, may include other applications 128 as may be desired in particular embodiments to provide additional features available to the user 102. For example, such other applications 128 may include security applications for implementing client-side security features, programmatic client applications for interfacing with appropriate application programming interfaces (APIs) over the network 160 or various other types of generally known programs and/or applications.

The client device 120, in one embodiment, may include one or more user identifiers 130, which may be implemented, for example, as operating system registry entries, cookies associated with the browser application 122, identifiers associated with hardware of the client device 120, or various other appropriate identifiers. The user identifier 130 may include attributes related to the user, such as personal information (e.g., a user name, password, photograph image, biometric id, address, phone number, etc.) and banking information (e.g., banking institution, credit card issuer, user account numbers, security information, etc.). In various implementations, the user identifier 130 may be passed with a user purchase request to the payment provider server 180, and the user identifier 130 may be used by the payment provider server 180 to associate the user 102 with a particular user account maintained by the payment provider server 180, in a manner as described herein.

The one or more merchant servers 140, in one embodiment, may be maintained, for example, by one or more merchants offering various items, such as products and/or services, in exchange for financial payment to be received from users, such as the user 102, over the network 160. In this regard, each of the one or more merchant servers 140 may include a database 142 for identifying available products and/or services, which may be made available to the client device 120 for viewing and purchase by the user 102. Accordingly, each of the merchant servers 140 may include a marketplace application 144, which may be configured to provide information over the network 160 to the browser application 122 of the client device 120. For example, the user 102 may interact with the marketplace application 144 through the browser application 122 over the network 160 to search and view various items, products and/or services identified in the database 142.

Each of the one or more merchant servers 140, in one embodiment, may include a checkout application 146, which may be configured to facilitate online purchase transactions by the user 102 of products and/or services identified by the marketplace application 144. In this regard, the checkout application 146 may be configured to accept payment information from the user 102 and/or from payment provider server 180 over the network 160.

Each of the one or more merchant servers 140, in one embodiment, may include one or more merchant identifiers 148, which may be included as part of the one or more items made available for purchase so that particular items are associated with particular merchants. The merchant identifier 148 may include attributes related to the merchant, such as business and banking information. In various implementations, the merchant identifier 148 may be passed with a user purchase request to the payment provider server 180 when the user 102 selects an item for purchase, and the merchant identifier 148 may be used by the payment provider server 180 to associate a particular item purchased with a particular merchant account maintained by the payment provider server 180, in a manner as described herein.

In various implementations, each of the one or more merchants having a related merchant server 140 may need to establish a merchant account with the payment provider server 180 so that the payment server provider 180 is able to process transactions having items offered for purchase by the merchants. When establishing a merchant account, each of the one or more merchants may need to provide business information, such as name, address, phone number, etc., and financial information, such as banking information, merchant account information, credit card information, payment processing information, etc.

In various implementations, as described herein, each of merchant servers 140 may be associated with a particular link (e.g., a link, such as a URL (Uniform Resource Locator) to an IP (Internet Protocol) address). In this regard, the payment provider server 180 may optionally redirect the browser application 122 to an appropriate webpage and/or merchant site of the merchant server 140 to facilitate purchase of a corresponding item and/or service available from at least one of the merchant servers 140.

The payment provider server 180, in one embodiment, may be maintained, for example, by an online payment service provider, which may provide payment processing for online transactions on behalf of the user 102 to an operator of the merchant server 140. In this regard, the payment provider server 180 includes one or more payment applications 182, which may be configured to interact with the client device 120 and/or each of the merchant servers 140 over the network 160 to facilitate the purchase of items, products and/or services by the user 102 from the merchant server 140. In one example, the payment provider server 180 may be provided by PayPal, Inc. of San Jose, Calif., USA.

The payment provider server 180, in one embodiment, may be configured to maintain a plurality of user and merchant accounts 184, each of which may include account information 186 associated with individual users, including the user 102, and the one or more merchants associated with the merchant servers 140. For example, account information 186 may include private financial information of user 102 and merchants 140, such as one or more account numbers, passwords, credit card information, banking information, or other types of financial information, which may be used to facilitate online transactions between the user 102 of the client device 120 and one or more merchants associated with the merchant servers 140. As such, the payment application 182 may be configured to interact with the one or more merchant servers 140 on behalf of the user 102 during a transaction with checkout application 146 without requiring the user 102 to provide account information 186 directly to the merchant server 180. In various embodiments, the methods and systems described herein may be modified to accommodate users and/or merchants that may or may not be associated with at least one existing user account and/or merchant account, respectively.

Payment provider server 180, in one embodiment, may include a content processing application 188, which may select content from a content database 190 to be provided to user 102. In various implementations, content processing application 188 may provide appropriate rules-based or heuristics-based facilities for selecting appropriate content for user 102 based on, for example, user identifier 130, user account 184, user account information 186, information received from merchant server 140, or other characteristics.

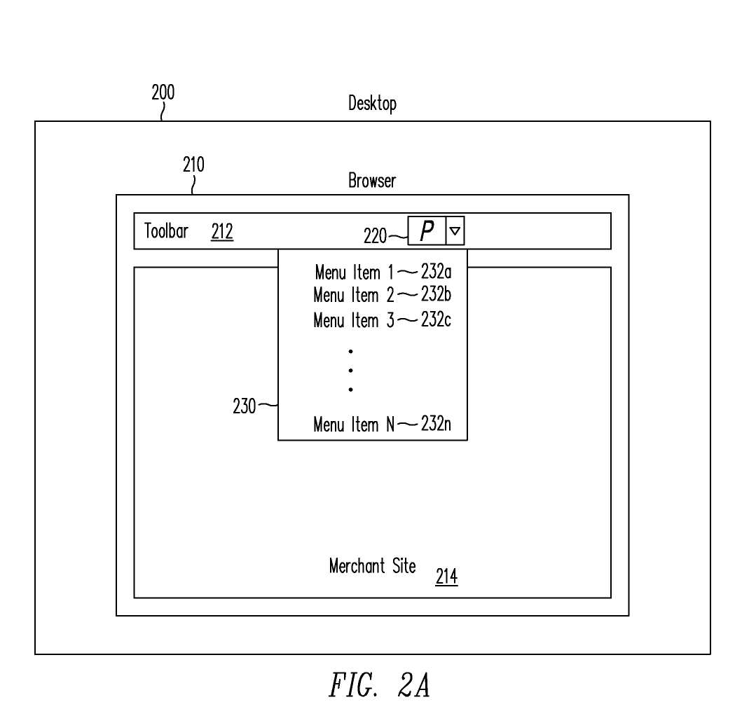

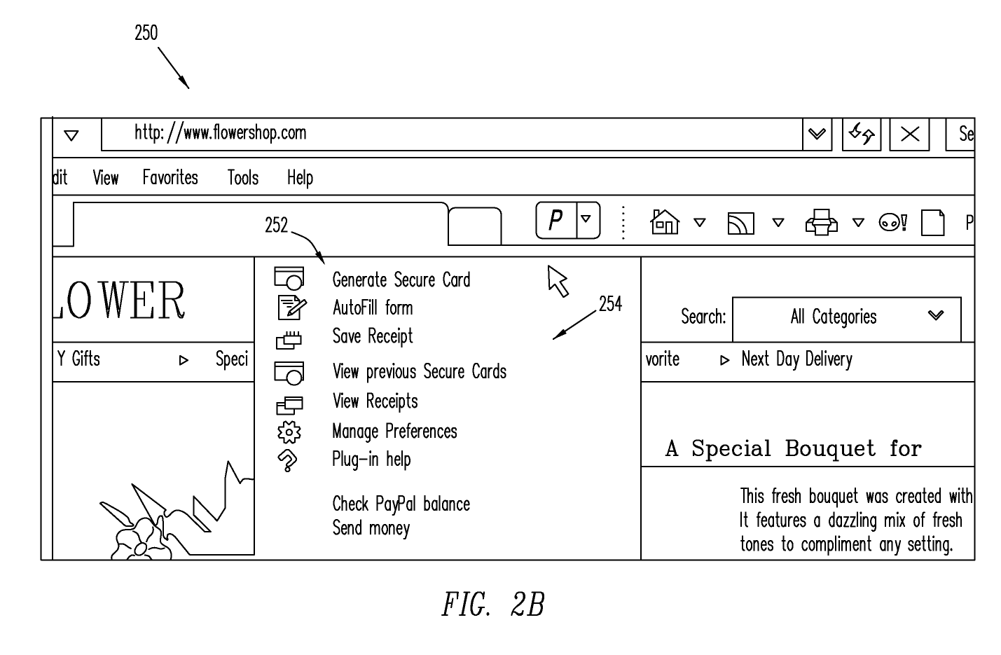

FIG. 2A shows one embodiment of the plug-in module 126 implemented in the browser application 122 on the client device 120 in reference to FIG. 1. In particular, FIG. 2A shows an image of a computer desktop 200 displaying a browser window 210 having a toolbar 212 with a plug-in toolbar feature 220 of the plug-in module 126. In one aspect, a display component of the client device 120 is adapted to display the browser window 210 in the computer desktop 200 with the plug-in toolbar feature 220 enabled in the toolbar 212.

In one implementation, the user 102 utilizes the browser application 122 to open the browser window 210 and access at least one of the merchant servers 140 via a merchant site 214 to view one or more items for purchase. When selected, the plug-in toolbar feature 220 is adapted to provide a menu item list 230 (e.g., drop-down selection menu or dashboard) on the desktop 200 so that the user 102 may select at least one of a plurality of menu items 232a-232n to execute a related command, which is described in greater detail herein. In one aspect, the drop-down window shade or dashboard of the plug-in toolbar feature 220 may be adapted to slide up or down from the toolbar 212 of the browser 210, which may be more aesthetically pleasing to the user 102 than a conventional pop-up window. In another aspect, the window shade or dashboard of the plug-in toolbar feature 220 may be adapted to drop down from the toolbar automatically when the plug-in module 126 detects a merchant site that may be requesting input from the user 102. The plug-in module 126 may detect this by analyzing the contents of the web page as displayed in the browser or by detecting a URL (i.e., uniform resource locator) corresponding to a known checkout page. For example, the plug-in module 126 may detect a checkout page on the merchant site requesting input of a bilking of shipping address or the input of a secure card number (e.g., debit card number or credit card number) to complete a purchase.

In one embodiment, a first menu item 232a for selection by the user 102 from the plug-in toolbar feature 220 may include a secure card feature that generates and provides a secure card number to the user 102. In various implementations, the secure card feature provides an easy selection of a single-use or multi-use secure card number for purchases, which is simpler than accessing one or more other websites to obtain secure credit card numbers. In one aspect, from the secure card feature of the plug-in toolbar feature 220, an extension of an expiration date for one or more multi-use secure card numbers may be requested form the payment provider server 180. Further scope and functionality of the secure card feature is described in greater detail herein.

In one implementation, the secure card number may comprise a secure debit card number that may be linked to the user's account 184 (e.g., debit account including a checking account and/or a savings account) at the payment provider server 180. As such, the user's account balance of the user's account 184 may be adapted to serve as a debit balance that may be decremented for each purchase from one or more of the merchants 140. In various implementations, the secure card number may comprise one or more of credit card numbers, debit card numbers, and/or various other payment instruments, such as prepaid debit numbers, without departing from the scope of the present disclosure.

In one embodiment, a second menu item 232b for selection by the user 102 from the plug-in toolbar feature 220 may include an auto-fill feature based on information associated with a user account 184 on the payment provider server 180. In various implementations, a single login to the user account 184 (e.g., a virtual credit card account) may automatically login to one or more merchant sites and auto-fill based on the user account information. The auto-fill feature may be based on transaction information, including user-generated information, such as billing and/or shipping information. User notifications may be based on the merchant site. The auto-fill feature may be user controlled, wherein the auto-fill feature may be turn-off for one or more particular merchant sites. Further scope and functionality of the auto-fill feature is described in greater detail herein.

In one embodiment, a third menu item 232c for selection by the user 102 from the plug-in toolbar feature 220 may include receipt generation and storage in the user's account 184 of the payment provider server 180. In various implementations, the user 102 may elect to forward purchase confirmation to the payment server provider 180, wherein the payment server provider 180 generates a purchase receipt that may then be stored in the user's account 184 of the payment provider server 180. In one aspect, the payment provider server 180 may provide the user 102 with a one-time use email address, wherein purchase confirmation may be sent to that email address, which may be automatically stored in the user's account 184 of the payment provider server 180.

In one implementation, FIG. 2B shows an example of screen shot of a browser 250 displaying various functions 252 that may be provided by the plug-in module 126 via the plug-in toolbar feature 220. These functions 252 may include generating a secure card (e.g., secure credit card number), auto-filling one or more forms and/or form fields (e.g., user-generated information including billing and/or shipping address information), saving one or more receipts (including storing and generating receipts), viewing previous secure cards, viewing receipts, checking the balance of one or more user accounts, etc. As shown in FIG. 2B, these functions 252 may be selected by the user 102 from a pull-down menu 254. As described in reference to FIG. 2A, the plug-in toolbar feature 220 of the plug-in module 126 may be positioned in the toolbar 212 of the browser 210 for accessibility. In various implementations, the plug-in toolbar feature 220 facilitates online financial transactions on a communication network, such as the Internet.

In one embodiment, when the plug-in module 126 detects that credit card information needs to be entered, an alert or notification may appear in the browser or drop down from the browser toolbar to inform the user to choose a single use credit card number for a one-time purchase or a multiple use number for return visits to the same sight. As such, the plug-in module 126 generates the secure card numbers for the user when the secure card feature of the plug-in toolbar feature 220 is selected. In another implementation, when the plug-in module 126 detects that transaction information (e.g., user-generated information including billing and/or shipping information) needs to be entered, an alert or notification may appear in the browser or drop down from the browser toolbar to inform the user to select the auto-fill menu item from the menu list of the plug-in toolbar feature 220. As such, the user's billing and shipping information may be automatically entered in the merchant site 214 when the user selects the auto-fill feature. In another implementation, when the plug-in module 126 detects that the purchase is completed, an alert or notification may appear in the browser or drop down from the browser toolbar to inform the user to store a receipt for review and tracking of online purchases. Further scope and functionality of these features is described in greater detail herein.

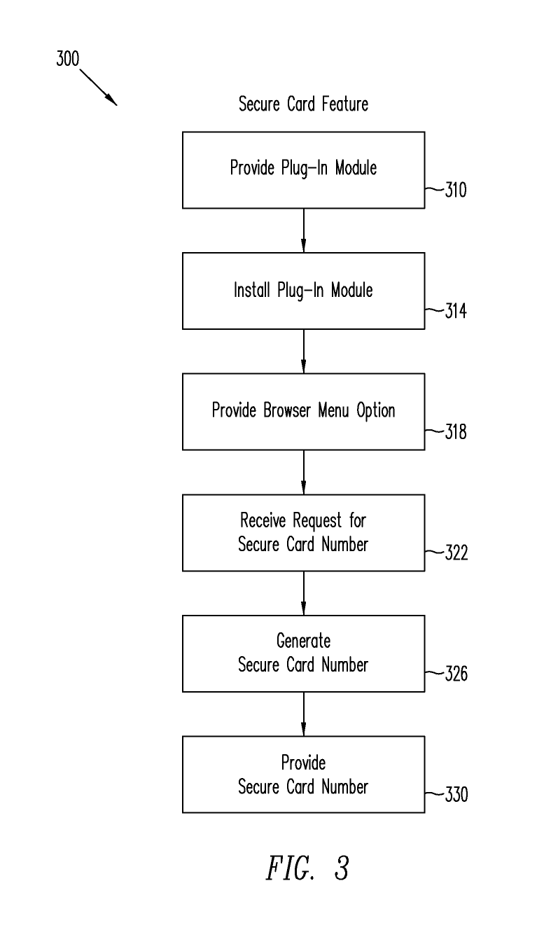

FIG. 3 shows one embodiment of a method 300 for generating secure credit card numbers with the plug-in toolbar feature 220 of the plug-in module 126 in reference to FIGS. 1-2. The method 300 provides the plug-in module 126 to the user 102 (block 310) for installation of the plug-in toolbar feature 220 on the client device 120 of the user 102 (block 314). Next, the browser menu 230 and menu options 232a-232n of the plug-in toolbar feature 220 are provided to the user 102 in the toolbar 212 of the browser 210 (block 318).

Next, in one implementation, when the user 102 requests a secure card number by selecting the secure card feature from the menu 230 of the plug-in toolbar feature 220, the plug-in module 126 sends the request to the payment provider server 180 via the network 160, and the payment provider server 180 receives the transmitted request (block 322). Next, the payment provider server 180 generates the secure card number (block 326) and sends the generated secure card number to the client device 120 via the network 160 so that the plug-in module 126 may then provide the generated secure card number to the user 102 via the browser 210 (block 330).

In various implementations, when requested, the plug-in module 126 and the plug-in toolbar feature 220 provides a way to generate one or more secure card numbers for the user 102. In one example, the user 102 may access the payment provider server 180 via the plug-in module 126 and the plug-in toolbar feature 220 to generate one or more secure card numbers. In general, secure card numbers may use available money from an account 184 associated with the user 102 or a bank account linked to the user's account 184. In one aspect, the plug-in module 126 may automatically enter the generated secure card number on the checkout page of the merchant site 214.

In various implementations, prior to generating one or more secure card numbers, the method 300 may include verifying the user information by verifying user identity with, for example, a user login name and password, and by accessing a user account based on the user information to verify the availability of monetary funds in a related user account. In one aspect, generating and providing one or more secure card numbers to the user authorizes the user to purchase items from one or more merchants.

In various implementations, upon user instruction, the plug-in module 126 may be installed and/or run on the client device 120. The user 102 may run the browser application 122 on the client device 120 to access at least one merchant site 214 via a related merchant server 140 to search and view one or more items for purchase. Upon installation of the plug-in module 126, the user 102 may be prompted to establish a user account with the payment provider server 180, wherein the user 102 may use the client device 120 to access the payment provider server 180 via the network 160. When establishing a user account, the user 102 may be asked to provide personal information, such as name, address, phone number, etc., and financial information, such as banking information, credit card information, etc. Information related to the user 102 may be packaged as the user identifier 130.

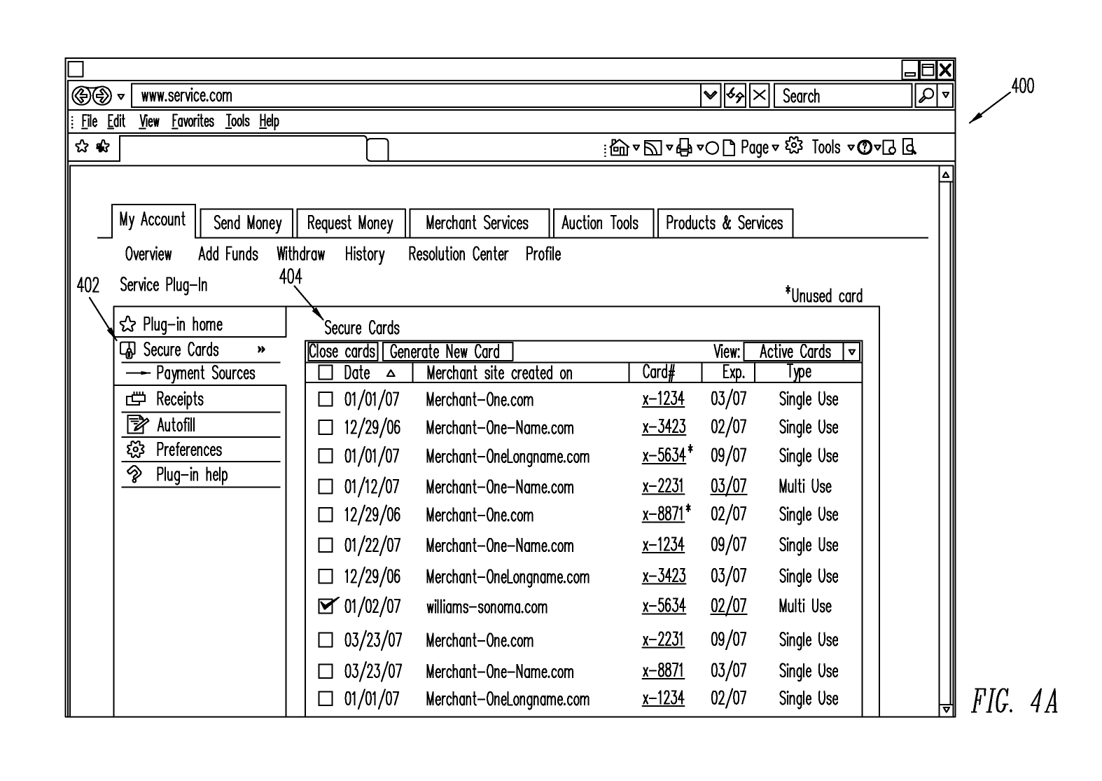

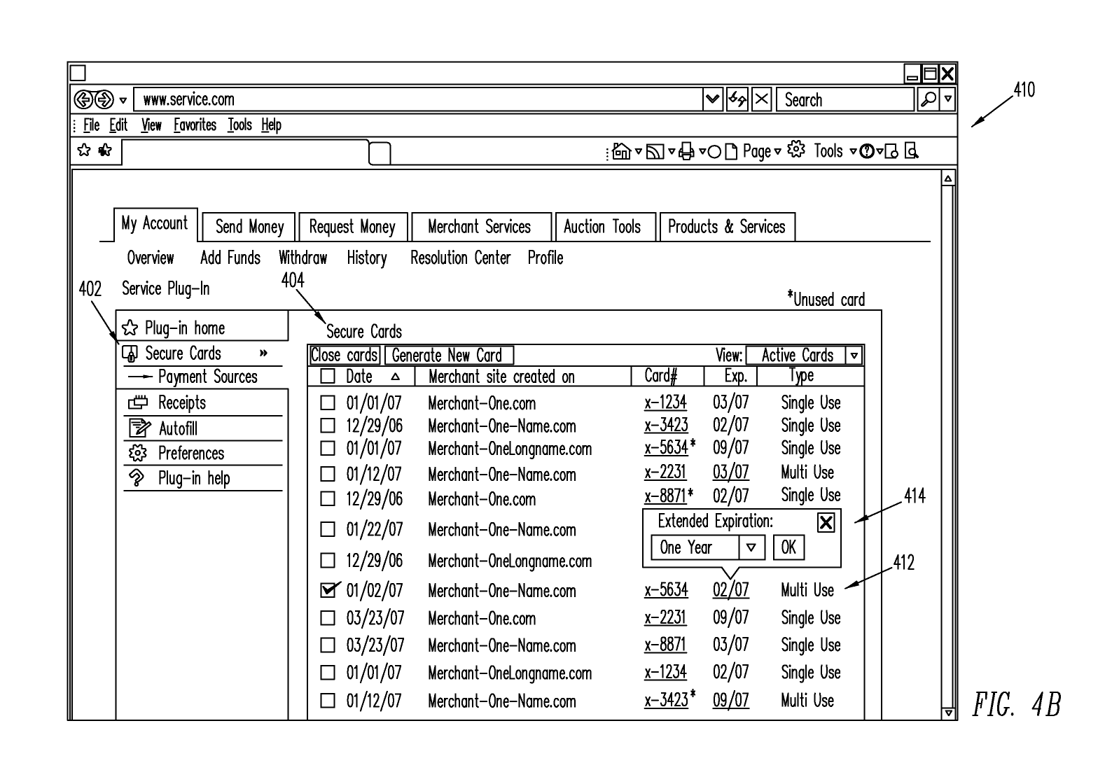

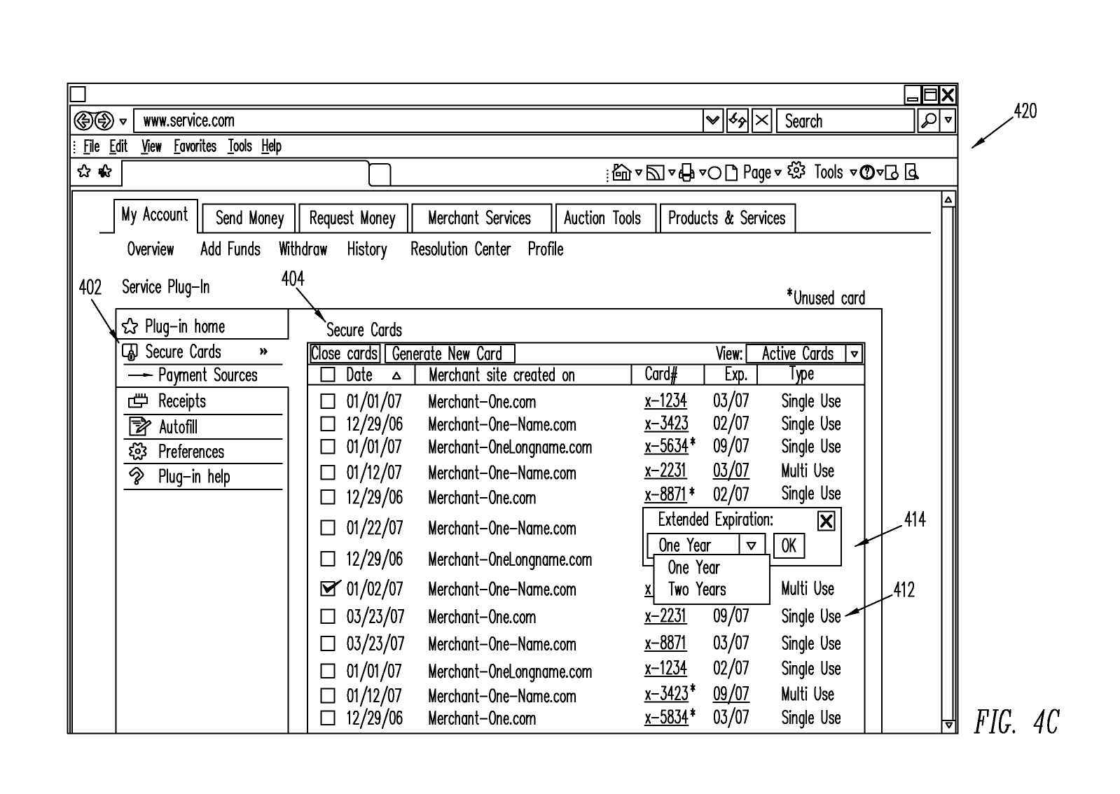

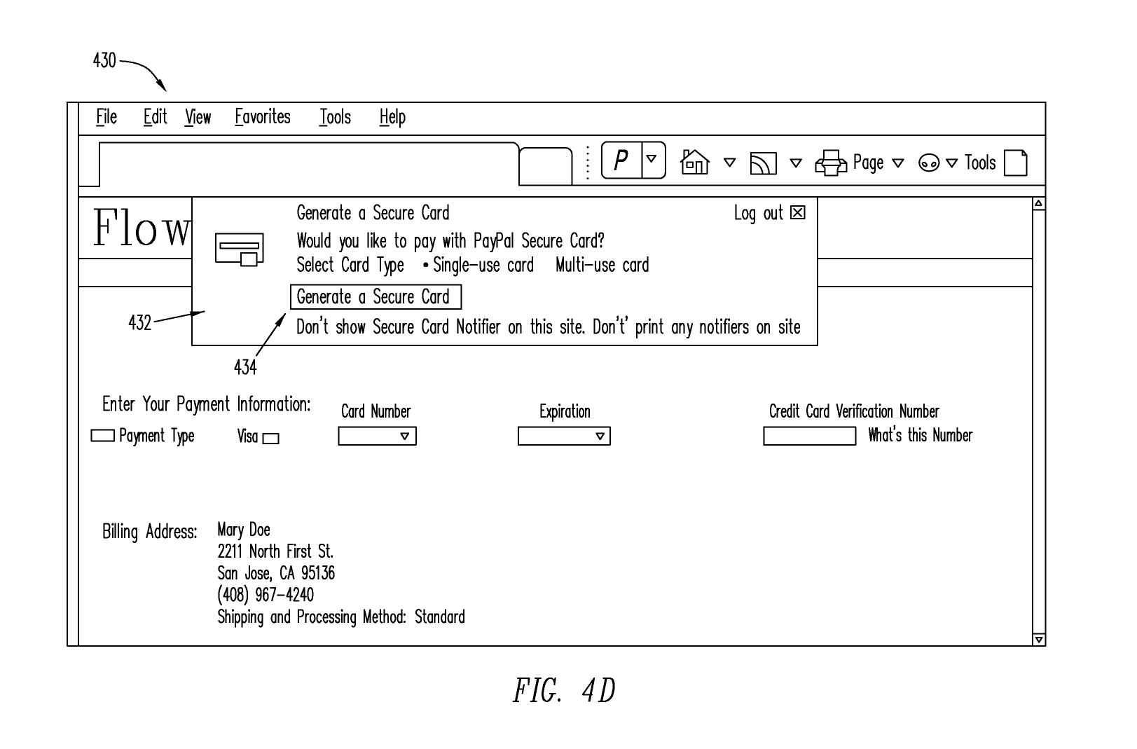

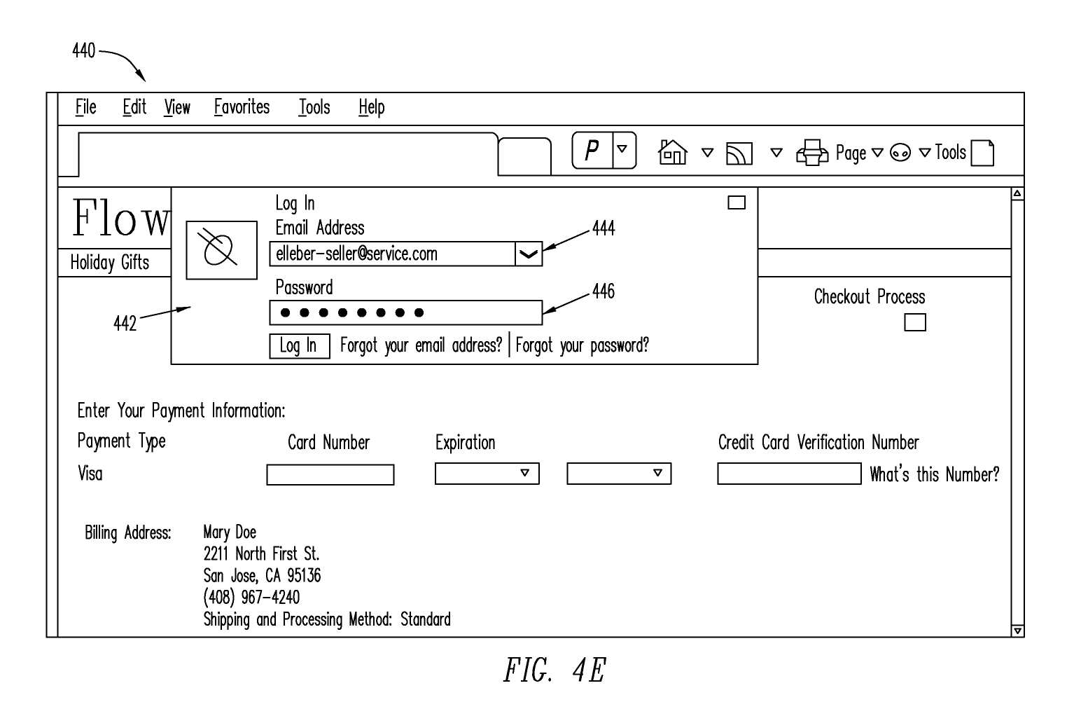

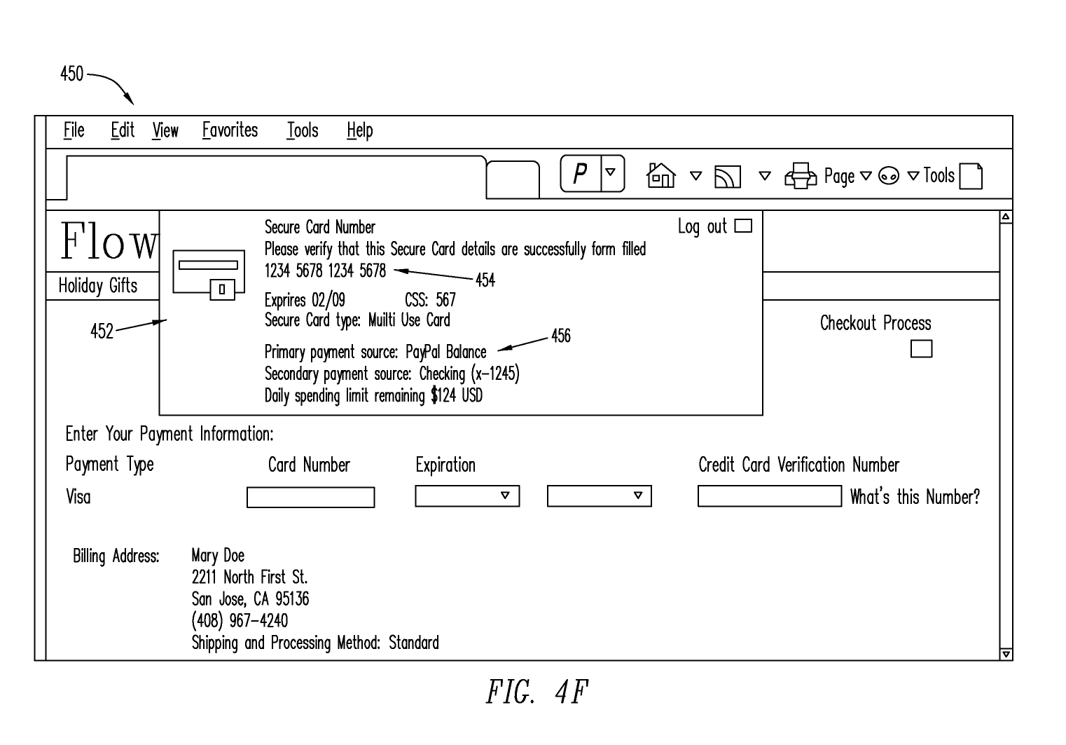

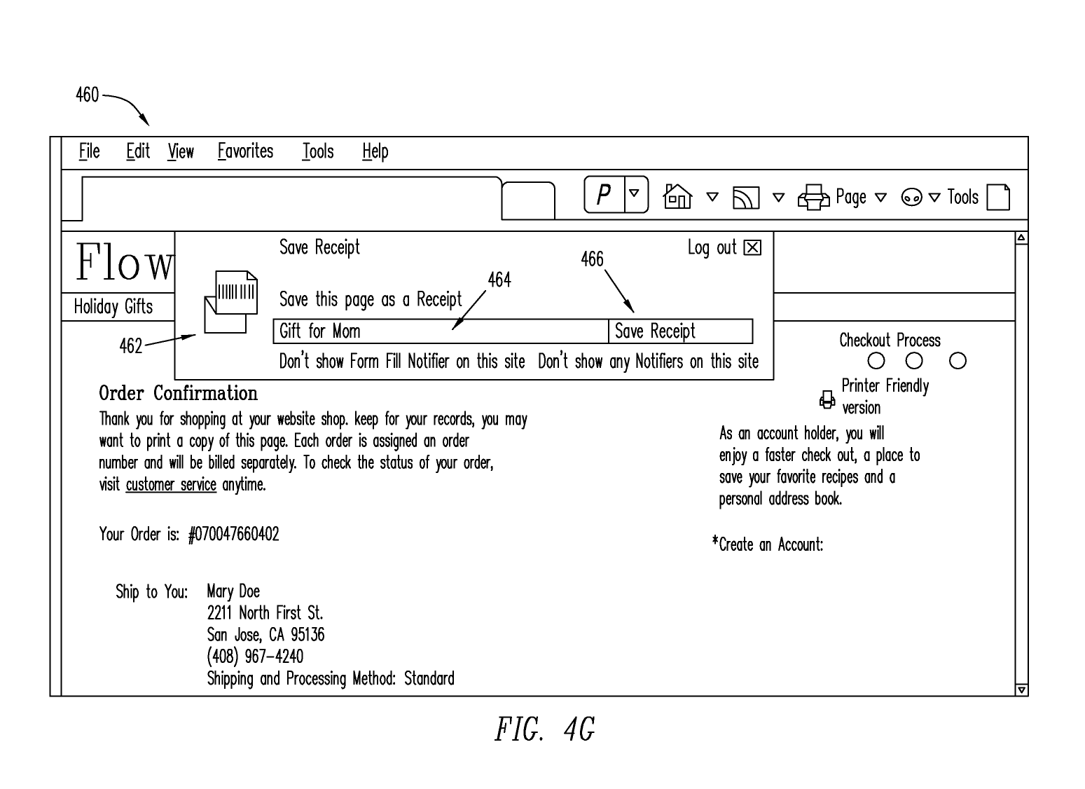

In one implementation, FIG. 4A shows a screen shot of a browser 400 displaying one embodiment of a management console website 402 provided to the client device 120 by the payment provider server 180. As shown in FIG. 4A, the user 102 may visit the management console website 402 to view the user's history of single-use and multi-use card number usage 404. FIGS. 4B-4C show screen shots of browsers 410, 420, respectively, displaying aspects of changing an expiration date 412 for a card number on the management console website 402. As shown in FIG. 4B, for multi-use card numbers, the user 102 may view the expiration date 412 and, by clicking on the expiration date 412, be provided with a pull-down menu 414 that provides options for extending the expiration date, as shown in FIG. 4C, by a specified time period 422 (e.g., by one month, two months, one year, two years, etc.).

In one implementation, FIG. 4D shows a screen shot of a browser 430 displaying a first notifier window 432. In one example, when the plug-in module 126 detects that the merchant's website is requesting payment information, the notifier window 432 may automatically be displayed and offer to generate a secure card number that can be entered into the merchant's web page. The user 102 may select either a single-use card or a multi-use card, and then by selecting (e.g., clicking on) the “Generate a Secure Card” button 434, the secure card number may be automatically filled into the appropriate field on the merchant's web page. FIG. 4E shows a screen shot of a browser 440 displaying a second notifier window 442. As shown in FIG. 4E, the user 102 may be prompted to login to the user's account 184 with the payment provider server 180 in the second notifier window 442. As shown in FIG. 4E, the user 102 may be prompted to enter the user account's login information 444 (e.g., email address) and password information 446 (e.g., security code number) after requesting the single-use or multi-use card number in the first notifier window 432. In one aspect, the user 102 may securely login to the payment provider server 180 via a website.

In one implementation, FIG. 4F shows a screen shot of a browser 450 displaying a third notifier window 452. After login of the user 102 for requesting a single-use or multi-use number, the third notifier window 452 may display the generated card number 454 and other information 456 that may be requested by the merchant 140 for verification purposes (e.g., expiration date and card verification number). In one aspect, the third notifier window 452 may include additional information about the user's account, such as the balance or spending limits. FIG. 4G shows a screen shot of a browser 460 displaying a fourth notifier window 462. As shown in FIG. 4G, after the purchase is completed, the fourth notifier window 462 may be displayed for querying the user 102 for a receipt name 464, if the user wishes to save the receipt. In one aspect, the user 102 may elect to save a receipt by selecting (e.g., clicking on) the “Save Receipt” button 466 to store a receipt on the payment provider server 180.

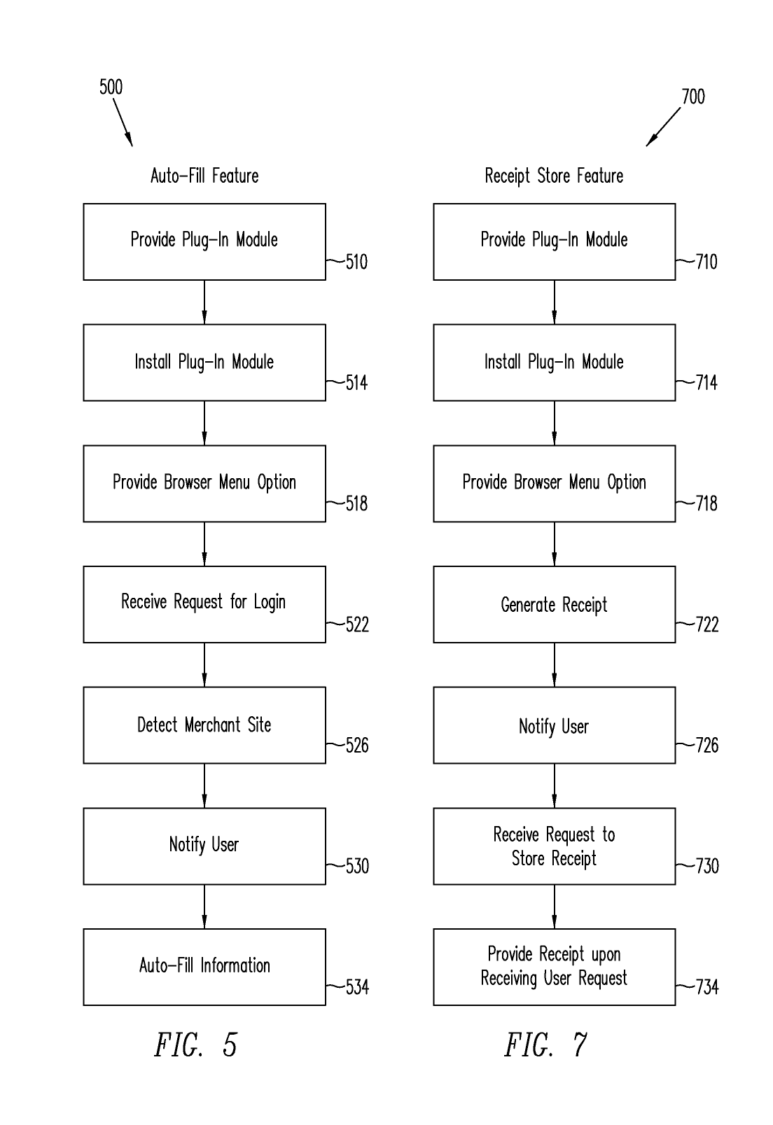

FIG. 5 shows one embodiment of a method 500 for auto-filling transaction data and information (e.g., user-generated information including billing and/or shipping information, which may be stored at the payment provider server 180 for verification and retrieval) with the plug-in module 126 and the plug-in toolbar feature 220 in reference to FIGS. 1-2. In various embodiments, the user-generated information includes various types of data and information related to the user including, for example, billing information of the user, shipping information of the user, information related to preferred merchants, third party addresses, and gift destination addresses. Moreover, it should be appreciated that these various types of information are made available for the auto-fill feature in accordance with the various embodiments and implementations of the present disclosure.

The method 500, in one implementation, provides the plug-in module 126 to the user 102 (block 510) for installation on the client device 120 of the user 102 (block 514). Next, the browser menu 230 and menu options 232a-232n of the plug-in toolbar feature 220 are provided to the user 102 in the toolbar 212 of the browser 210 (block 518).

Next, in one implementation, when the user 102 requests a login to the payment provider server 180 by selecting the auto-fill feature from the menu 230 of the plug-in toolbar feature 220, the plug-in module 126 sends the request to the payment provider server 180 via the network 160, and the payment provider server 180 receives the transmitted request for login (block 522). Next, once logged-in, the payment provider server 180 provides transaction information including user-generated information, such as billing and/or shipping information, for the logged-in user 102 to the plug-in module 126 so that, when the plug-in module 126 detects a purchase on the merchant site 214 (block 526), the plug-in module 126 alerts or notifies the user 102 to auto-fill the transaction information (block 530). Next, upon accepting the notification for auto-fill, the plug-in module 126 auto-fills the transaction information on the merchant site 214 (block 534).

In various implementations, a “Don't ask me again” feature and/or prompt may be included as part of the plug-in module 126 and toolbar feature 220, wherein this feature is a value-add to the auto-fill feature. This feature may be added to any of the notifiers and/or prompts described herein. For example, when the user 102 becomes annoyed by a notifier and/or prompt, the user 102 may elect to do at least one of the following. In another example, the user 102 may become annoyed if asked to login too many times for basic activities. As such, logging in for the auto-fill feature may be an option. Hence, the user 102, for example, may elect to turn this option ‘on’ or ‘off’ at any time when logged into the payment provider server 180 (e.g., the user 102 may change plug-in preferences). However, in various implementations, editing plug-in preferences may be done locally from the client device 120 within the plug-in module 126, and thus may not need login to the payment provider server 180 for editing plug-in preferences. In one implementation, the payment provider server 180 may automatically update the user's plug-in preferences from the client device 120 when the user 102 logs into the payment provider server 180.

In one implementation, the user 102 may elect to block a specific website from having one or more notifiers and/or prompts drop down when browsing. This may apply to all notifiers and/or prompts on the specific website. For example, the user 102 may not want the plug-in module 126 to interact while on a particular web site when shopping activities are not usually performed. In another implementation, the user 102 may elect to block a specific notifier type (e.g., auto-fill, secure card number, fraud site alert) from showing up, regardless of what website is being accessed. For example, the user 102 may elect to only use particular features of the plug-in module 126, wherein the user 102 may elect to block the secure card number notifier during a financial transaction. In this instance, the user 102 may not receive a receipts identifier because the receipt notifier may be dependent on the secure card notifier. Thus, by blocking the secure card notifier, the user 102 may block the receipt notifier. It should be appreciated that these and other notifiers may edited in the notifier window or in the parameters and/or preferences edit page of the user's account when logged into the payment provider server 180.

In various implementations, the plug-in module 126 may be consistently updated on the client device 120 at the time of login with current user information, such as a more current address designate by the user 102 with user-generated information. As such, the more up-to-date user-generated information related to the user 102 may be carried to each necessary component of the system 100 as, for example, a traveling profile. Moreover, the user-generated information may be centrally stored and maintained as parameters and/or preferences the user accounts 184 and/or the content database 190 a the payment provider server 180. Hence, in one aspect, the user 102 may not be required to change parameters and/or preferences only on the client device 120, wherein changes may be made on another client device, such as a shared computer.

In various implementations, when requested, the plug-in module 126 and the plug-in toolbar feature 220 provides a way to auto-fill user-generated information stored at the payment provider server 180, such as billing and shipping information, of the user 102 during purchase of one or more items from a merchant site 214. In one example, the user 102 may access the payment provider server 180 via the plug-in module 126 and the plug-in toolbar feature 220 to enable the auto-fill feature. In one aspect, if the user 102 is logged-in to the payment provider server 180, the plug-in module 126 may automatically enter user-generated information including billing and/or shipping information of the user 102 on the checkout page of the merchant site 214 without user permission.

In one embodiment, the method 500, plug-in module 126 and the toolbar feature 220 may include an express checkout feature. The express checkout feature, in various implementations, is provided by the payment provider server 180 for use with integrated merchants, such as merchants 140 that have merchant accounts 184 with the payment provider server 180. The express checkout feature simplifies how users 102 checkout on merchant websites when they want to pay the merchant directly using the payment provider sever 180 instead of another way, such as using a secure card number.

In various implementations of the express checkout feature, the user 102 may need to have a user account 184 with the payment provider server 180, the user 102 may need to have the plug-in module 126 installed on a client device 120, and the user 102 elects to pay the merchant 140 via the user account 184 a payment method. The user 102 may have the ability to generate and store receipts with the express checkout feature.

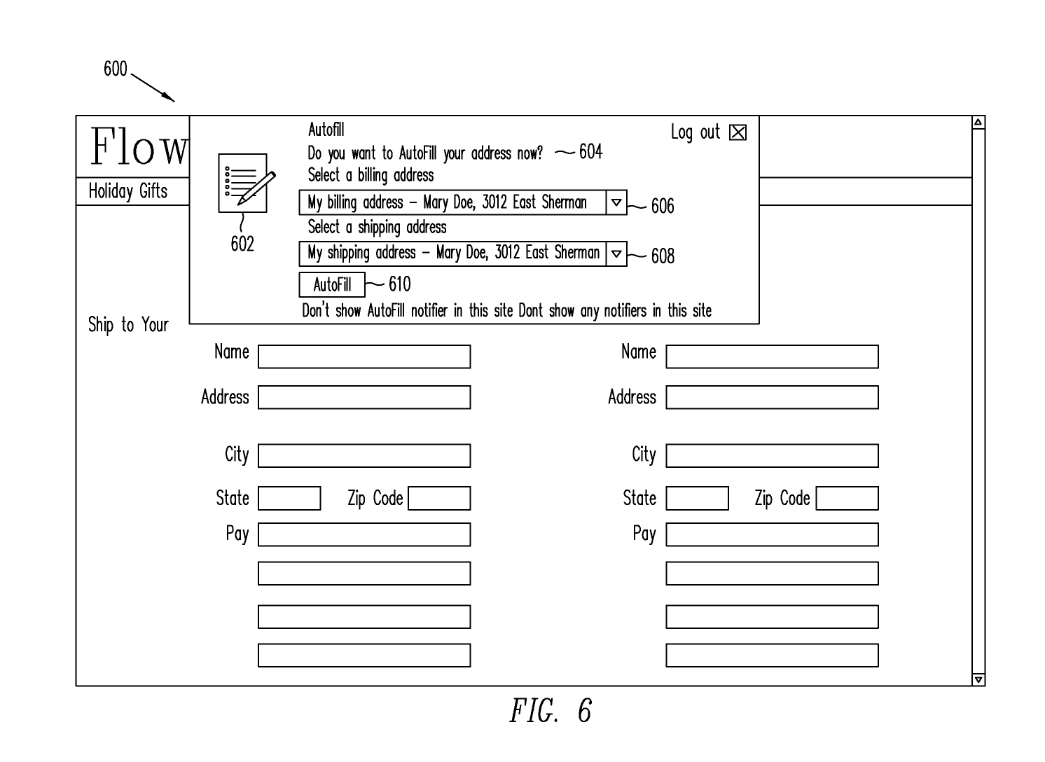

In one implementation, FIG. 6 shows a screen shot of a browser 600 displaying a drop-down toolbar 602 that may be automatically displayed when the plug-in module 126 detects that the browser application 600 is displaying a checkout page requesting shipping and/or billing information 604. In one example, the web page displayed by the browser 600 is requesting shipping and billing address information 604. As such, the drop-down toolbar 602 may provide two drop-down menus 606, 608 to enable the user 102 to select different addresses to use for entering shipping and billing address information. Once the user 102 has selected the desired addresses, or if the user desires to select one or more default addresses previously stored with the payment provider server 180, the user 102 may select (e.g., click on) an “Auto-Fill” button 610, and the shipping and/or billing address information may be entered in the appropriate fields 606, 608.

FIG. 7 shows one embodiment of a method 700 for storing receipts with the plug-in module 126 and the plug-in toolbar feature 220 in reference to FIGS. 1-2. The method 700 provides the plug-in module 126 to the user 102 (block 710) for installation on the client device 120 of the user 102 (block 314). Next, the browser menu 230 and menu options 232a-232n of the plug-in toolbar feature 220 are provided to the user 102 in the toolbar 212 of the browser 210 (block 318).

Next, in one implementation, when the user 102 purchases an item from a merchant site 214, a receipt is generated by the payment provider server 180 (block 722). Next, the payment provider server 180 notifies the user 102 via the plug-in module 126 that the receipt is available to view and/or store (block 726). In one example, upon direction of the payment provider server 180, the plug-in module 126 alerts or notifies the user 102 that the receipt is available for viewing and/or storage. Next, the user 102 may select the store receipt feature from the menu 230 of the plug-in toolbar feature 220 (block 730). In one example, the receipts for the user 102 may be stored on the payment provider server 180 in the user account 184 associated to the user 102. Next, the user 102 may select the view or review receipt feature from the menu 230 of the plug-in toolbar feature 220 (block 734). In one example, the payment provider server 180 provides stored receipts to the user 102 upon request to view or review the stored receipts when the view or review receipt feature is selected from the menu 230 of the plug-in toolbar feature 220.

In various implementations, when requested, the plug-in module 220 provides a way to store, view and review receipts for the user 102. In one example, the user 102 may access the payment provider server 180 via the plug-in module 126 to view or review receipts stored in the user account 184 associated with the user 102. In one aspect, the plug-in module 126 may automatically store receipts and/or provide the receipts to the user 102 after a purchase from a merchant site 214 is completed.

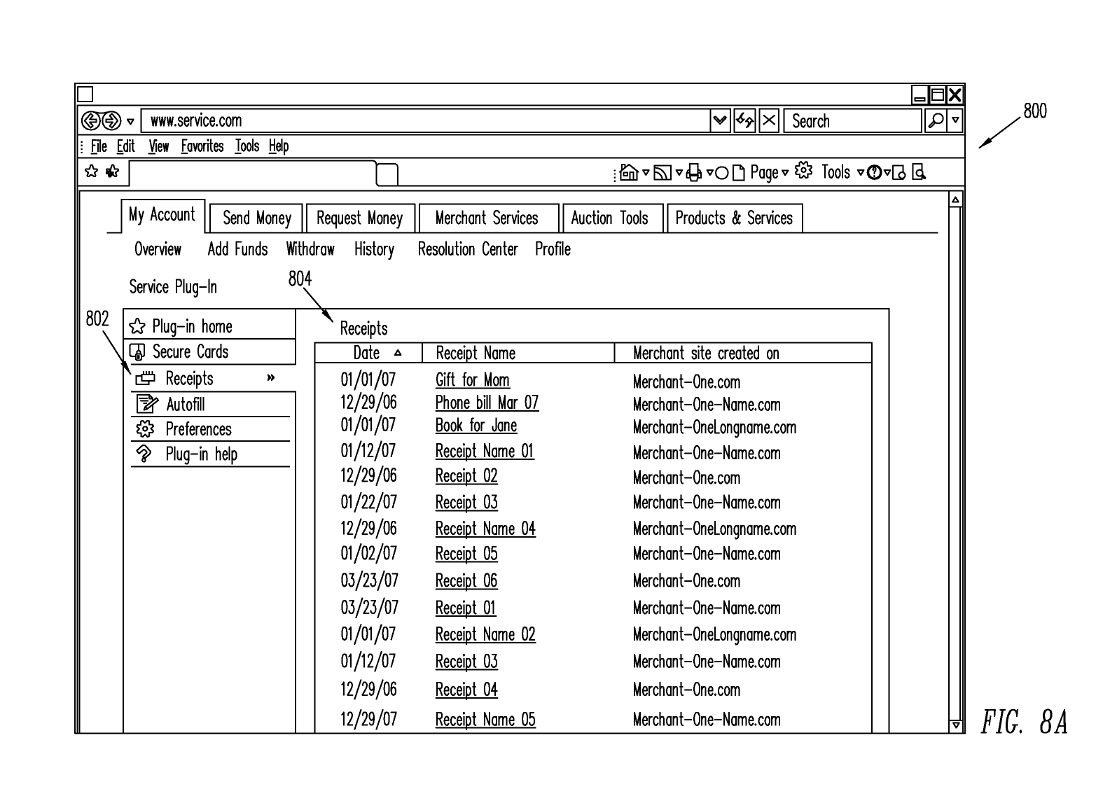

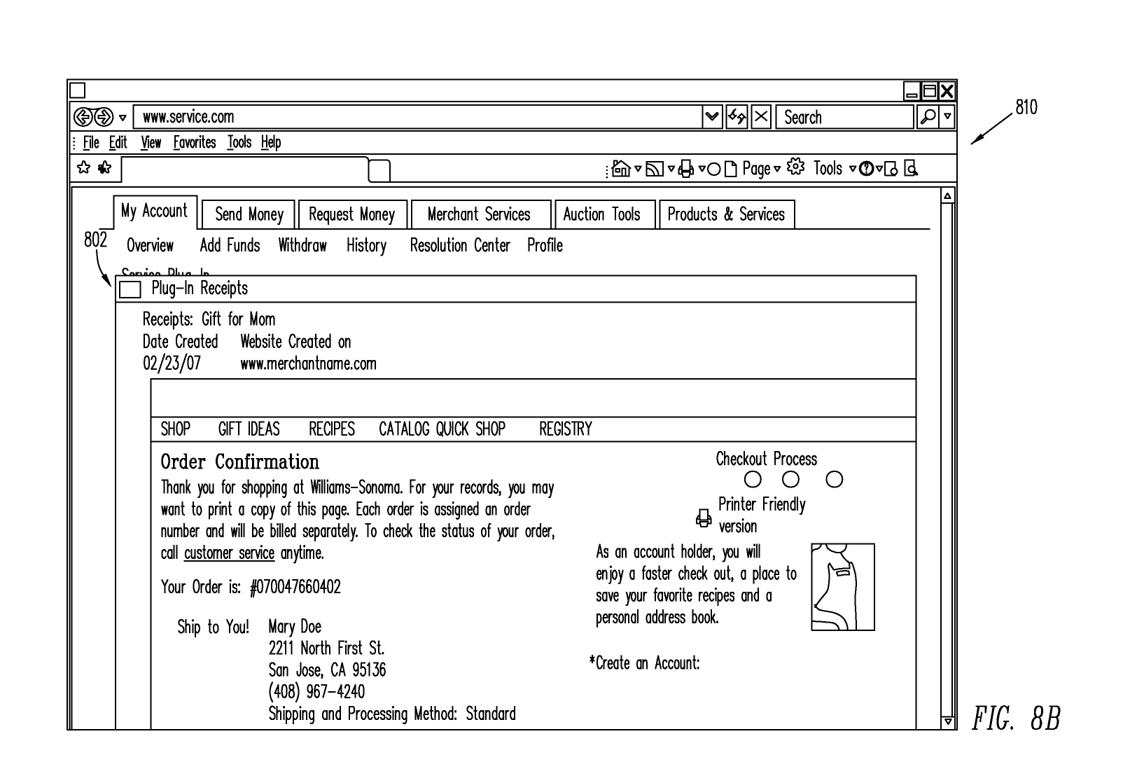

In one implementation, FIG. 8A shows a screen shot of a browser 800 displaying one embodiment of a management console website 802 provided to the client device 120 by the payment provider server 180. As shown in FIG. 8A, the user 102 may visit the management console website 802 to view one or more receipts 804 for purchases made using the payment provider's card numbers. FIG. 8B shows a screen shot of a browser 810 displaying one embodiment of a selected receipt 812 by the management console website 802. As shown in FIG. 8A, by clicking on one of the receipt names listed in the management console website 802, a copy of the receipt 812 provided by either a merchant 140 or by the payment provider server 180 via a merchant website (e.g., an order confirmation web page) may be displayed to the user 102 via the client device 120.

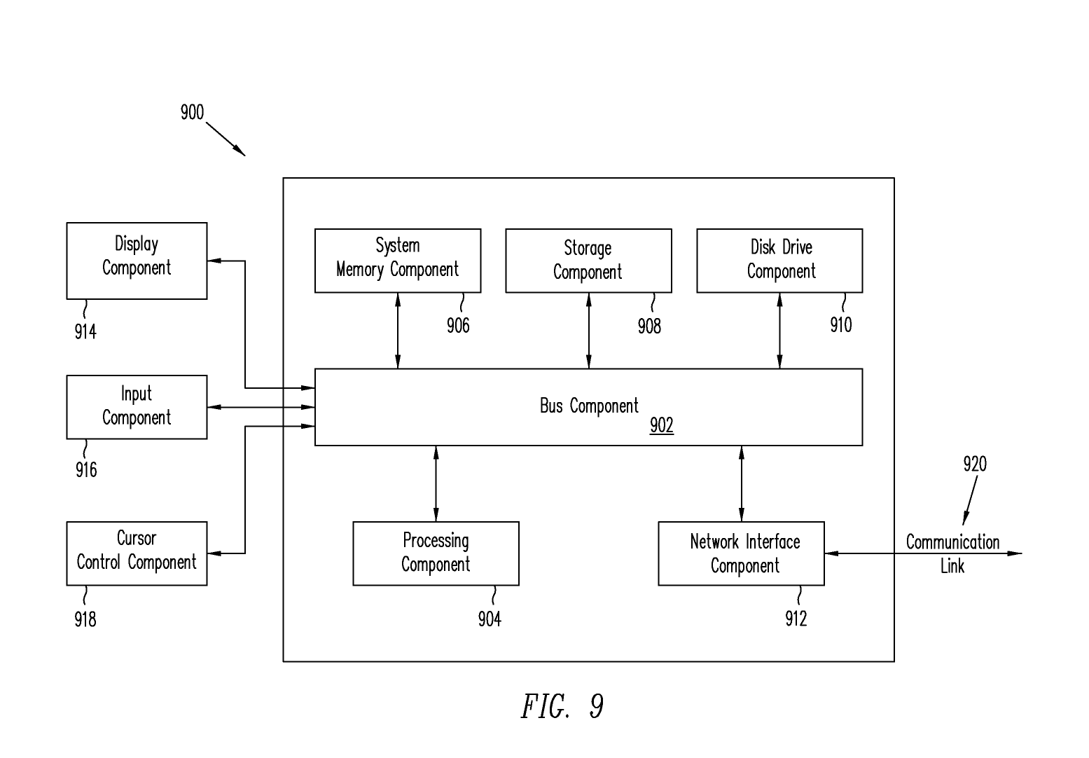

FIG. 9 is a block diagram of a computer system 900 suitable for implementing embodiments of the present disclosure, including the client device 120, the one or more merchant devices 140, and the payment processing device 180. In various implementations, the client device 140 may comprise a personal computing device, such as a personal computer, laptop, PDA, etc., the one or more merchant devices 140 may comprise a network computing device, such as a server, and the payment processing device may comprise a network computing device, such as a server. Thus, it should be appreciated that the devices 120, 140, 180 may be implemented as computer system 900 in a manner as follows.

In accordance with various embodiments of the invention, computer system 900, such as a personal computer and/or a network server, includes a bus 902 or other communication mechanism for communicating information, which interconnects subsystems and components, such as processing component 904 (e.g., processor, micro-controller, digital signal processor (DSP), etc.), system memory component 906 (e.g., RAM), static storage component 908 (e.g., ROM), disk drive component 910 (e.g., magnetic or optical), network interface component 912 (e.g., modem or Ethernet card), display component 914 (e.g., CRT or LCD), input component 916 (e.g., keyboard), and cursor control component 918 (e.g., mouse or trackball). In one implementation, disk drive component 910 may comprise a database having one or more disk drive components.

In accordance with embodiments of the invention, computer system 900 performs specific operations by processor 904 executing one or more sequences of one or more instructions contained in system memory component 906. Such instructions may be read into system memory component 906 from another computer readable medium, such as static storage component 908 or disk drive component 910. In other embodiments, hard-wired circuitry may be used in place of or in combination with software instructions to implement the invention.

Logic may be encoded in a computer readable medium, which may refer to any medium that participates in providing instructions to processor 904 for execution. Such a medium may take many forms, including but not limited to, non-volatile media, volatile media, and transmission media. In various implementations, non-volatile media includes optical or magnetic disks, such as disk drive component 910, volatile media includes dynamic memory, such as system memory component 906, and transmission media includes coaxial cables, copper wire, and fiber optics, including wires that comprise bus 902. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the invention, execution of instruction sequences to practice the invention may be performed by computer system 900. In various other embodiments of the invention, a plurality of computer systems 900 coupled by communication link 920 (e.g., network 160 of FIG. 1, LAN, WLAN, PTSN, or various other wired or wireless networks) may perform instruction sequences to practice the invention in coordination with one another.

Computer system 900 may transmit and receive messages, data, information and instructions, including one or more programs (i.e., application code) through communication link 920 and network interface component 912. Received program code may be executed by processor 904 as received and/or stored in disk drive component 910 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure.

Having thus described embodiments of the invention, persons of ordinary skill in the art will recognize that changes may be made in form and detail without departing from the scope of the invention. Thus, the invention is limited only by the claims.

What is claimed is:

1. A system for facilitating financial transactions over a network, the system comprising:
a first component adapted to communicate with a user via a client device over the network; and
a second component adapted to receive a login request from the user via the client device over the network and process the login request by accessing an account related to the user based on user information passed with the login request,
wherein the second component provides transaction information from the user account to the client device for auto-fill of the transaction information during a financial transaction with a merchant.

2. The system of claim 1, wherein the transaction information comprises user-generated information.

3. The system of claim 2, wherein the user-generated information includes at least one of billing information and shipping information.

4. The system of claim 1, wherein the first component is adapted to communicate with the client device via a browser application having a plug-in module.

5. The system of claim 4, wherein the plug-in module is adapted to detect the financial transaction on a merchant site of the merchant.

6. The system of claim 4, wherein the plug-in module is adapted to notify the user to auto-fill the transaction information.

7. The system of claim 4, wherein the plug-in module is adapted to auto-fill the transaction information in a form field on a merchant site of the merchant when instructed by the user.

8. The system of claim 4, wherein the plug-in module is adapted to provide a drop-down dashboard to the user from a toolbar of the browser application.

9. The system of claim 8, wherein the drop-down dashboard provides selection of auto-filling the transaction information of the user.

10. The system of claim 1, wherein the second component is adapted to verify the identity of the user based on the user information passed with the login request.

11. The system of claim 1, wherein the second component comprises a payment processing application adapted to interface with one or more merchant devices on behalf of the client device during a financial transaction.

12. The system of claim 11, wherein the payment processing application is adapted to interface with the user via the client device over the network to facilitate financial transactions between the client device and the one or more merchant devices.

13. The system of claim 1, further comprising a third component adapted to maintain a plurality of accounts for one or more users and merchants, the accounts including account information related to the one or more users and merchants.

14. The system of claim 13, wherein the account information comprises private financial information of the users and merchants including at least one or more account numbers, passwords, address information, credit card information, and banking information.

15. A method for facilitating financial transactions over a network, the method comprising:
receiving a login request from a user via the network, the request includes information related to the user;
processing the request by accessing an account related to the user based on the user information passed with the login request; and
completing the request by providing transaction information from the user account to the client device via the network for auto-fill of the transaction information during a financial transaction with a merchant.

16. The method of claim 15, wherein the transaction information comprises user-generated information.

17. The method of claim 16, wherein the user-generated information comprises at least one of billing information and shipping information.

18. The method of claim 15, further comprising verifying the identity of the user.

19. The method of claim 15, further comprising maintaining a plurality of accounts including the user account that includes financial information related to the user.

20. The method of claim 15, further comprising providing a plug-in module to the user, wherein the plug-in module provides a browser login request mechanism to the user via a client device operated by the user.

21. The method of claim 20, wherein the plug-in module comprises a software application executable by a processor on a client device used by the user.

22. The method of claim 20, wherein the plug-in module is adapted to allow the user to login to the account related to the user for identity verification based on the user information passed with the request.

23. Software encoded in one or more computer readable media and when executed operable to:
receive a login request from a user via the network, the request includes information related to the user;
process the request by accessing an account related to the user based on the user information passed with the login request; and
complete the request by providing transaction information from the user account to the client device via the network for auto-fill of the transaction information during a financial transaction with a merchant.
